(19) United States
(12) Patent Application Publication
(10) Pub. No.: US 2020/0074650 A1
(43) Pub. Date: Mar. 5, 2020

(54) DISTANCE IMAGE DISPLAY APPARATUS AND DISTANCE IMAGE DISPLAY METHOD

(71) Applicant: Fanuc Corporation, Yamanashi (JP)

(72) Inventors: Yuta Namiki, Yamanashi (JP); Yuusuke Murata, Yamanashi (JP)

(73) Assignee: Fanuc Corporation, Yamanashi (JP)

(21) Appl. No.: 16/533,401

(22) Filed: Aug. 6, 2019

(30) Foreign Application Priority Data
Aug. 29, 2018 (JP) 2018-160093

(51) Int. Cl. G06T 7/50; H04N 13/204; G06T 7/90; G06T 11/20

(52) U.S. Cl. CPC G06T 7/50; H04N 13/204; G06T 2207/10028; G06T 11/20; G06T 2200/24; G06T 7/90

(57) ABSTRACT

A distance image display apparatus includes: a distance range specifying unit that allows an operator to specify a partial distance range desired to be displayed within a first distance image in which, based on three-dimensional information of an object acquired by a three-dimensional camera, a color or density corresponding to a distance from the three-dimensional camera of the object positioned at each pixel is assigned to each of the pixels; a distance image generation unit that generates a second distance image in which a color or density of each of the pixels positioned within the specified distance range is reassigned so as to correspond to a distance from the three-dimensional camera; and a display unit that displays the generated second distance image.

### CROSS-REFERENCE TO RELATED APPLICATIONS

This application claims the benefit of Japanese Patent Application No. 2018-160093, the content of which is incorporated herein by reference.

### TECHNICAL FIELD

The present invention relates to a distance image display apparatus and a distance image display method.

### BACKGROUND ART

Conventionally, there has been known a display method for displaying three-dimensional information acquired by a three-dimensional camera as a distance image (e.g., PTL 1).

A distance image is a representation of three-dimensional information of an object acquired in the visual field range of a three-dimensional camera in the form of an image and is a representation of the height or the distance from the three-dimensional camera of the object at the position of each pixel in the image using the brightness or color of the pixel.

### CITATION LIST

### Patent Literature

### {PTL 1} Japanese Unexamined Patent Application, Publication No. 2013-101045

### SUMMARY OF INVENTION

An aspect of the present invention is a distance image display apparatus including: a distance range specifying unit that allows an operator to specify a distance range desired to be displayed within a first distance image in which, based on three-dimensional information of an object acquired by a three-dimensional camera, a color or density corresponding to a distance of the object from the three-dimensional camera at each pixel is assigned to each of the pixels; a distance image generation unit that generates a second distance image in which a color or density of each of the pixels positioned within the specified distance range is reassigned so as to correspond to a distance from the three-dimensional camera; and a display unit that displays the generated second distance image.

Another aspect of the present invention is a distance image display method including: allowing an operator to specify a distance range desired to be displayed within a first distance image in which, based on three-dimensional information of an object acquired by a three-dimensional camera, a color or density corresponding to a distance of the object from the three-dimensional camera at each pixel is assigned to each of the pixels; generating a second distance image in which a color or density of each of the pixels positioned within the specified distance range is reassigned so as to correspond to a distance from the three-dimensional camera; and displaying the generated second distance image.

### BRIEF DESCRIPTION OF DRAWINGS

FIG. 1 is an overall configuration diagram showing an example of a distance image display system including a distance image display apparatus according to an embodiment of the present invention.

FIG. 2 is a block diagram showing the distance image display apparatus in FIG. 1.

FIG. 3 is a diagram showing an example of a first distance image outputted by an image processing apparatus in the distance image display system in FIG. 1.

FIG. 4 is a diagram for describing an operation for specifying a cutting plane on the first distance image shown in FIG. 3.

FIG. 5 is a diagram for describing a contour shape of the object along the cutting plane in FIG. 4, and an operation for specifying a distance range.

FIG. 6 is a diagram showing an example of a second distance image generated by a distance image generation unit based on the distance range specified in FIG. 5.

FIG. 7 is a flowchart for describing a distance image display method according to an embodiment of the present invention using the distance image display apparatus in FIG. 2.

### DESCRIPTION OF EMBODIMENTS

A distance image display apparatus 1 and a distance image display method according to an embodiment of the present invention will be described below with reference to the drawings.

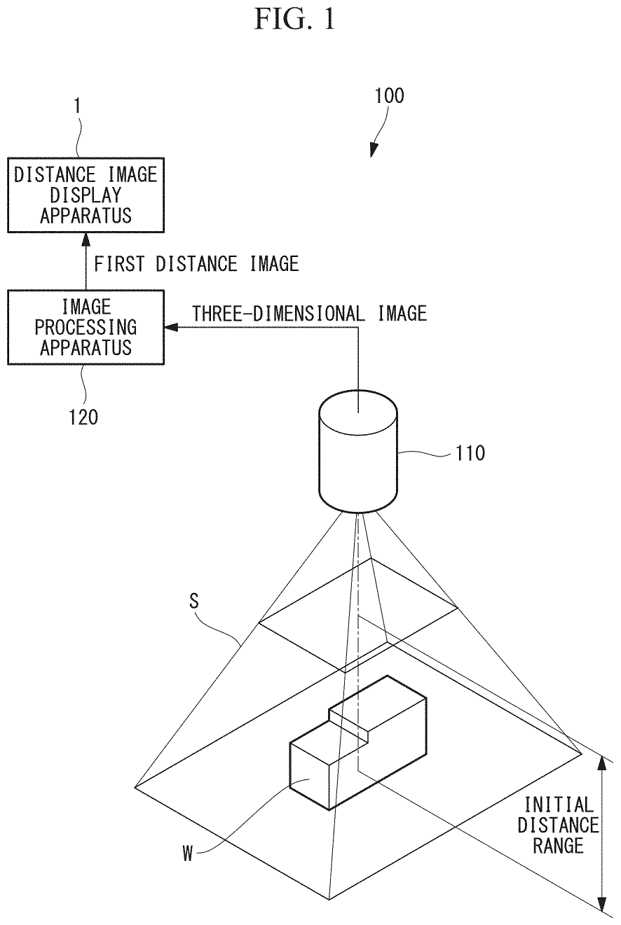

The distance image display apparatus 1 according to this embodiment is included in a distance image display system 100 shown in FIG. 1.

The distance image display system 100 includes a three-dimensional camera 110 that is mounted at the tip of an arm of a robot and acquires a three-dimensional image (three-dimensional information) of an object W, an image processing apparatus 120 that processes the three-dimensional image acquired by the three-dimensional camera 110 to generate a first distance image G1, and a distance image display apparatus 1 according to this embodiment to which the first distance image G1 generated by the image processing apparatus 120 is inputted.

The three-dimensional image acquired by the three-dimensional camera 110 is stored by capturing the object W placed within a visual field range S of the three-dimensional camera 110, and associating distance information from the three-dimensional camera 110 of each point on a surface of the object W corresponding to each of pixels C1 and C2 with each of the pixels C1 and C2.

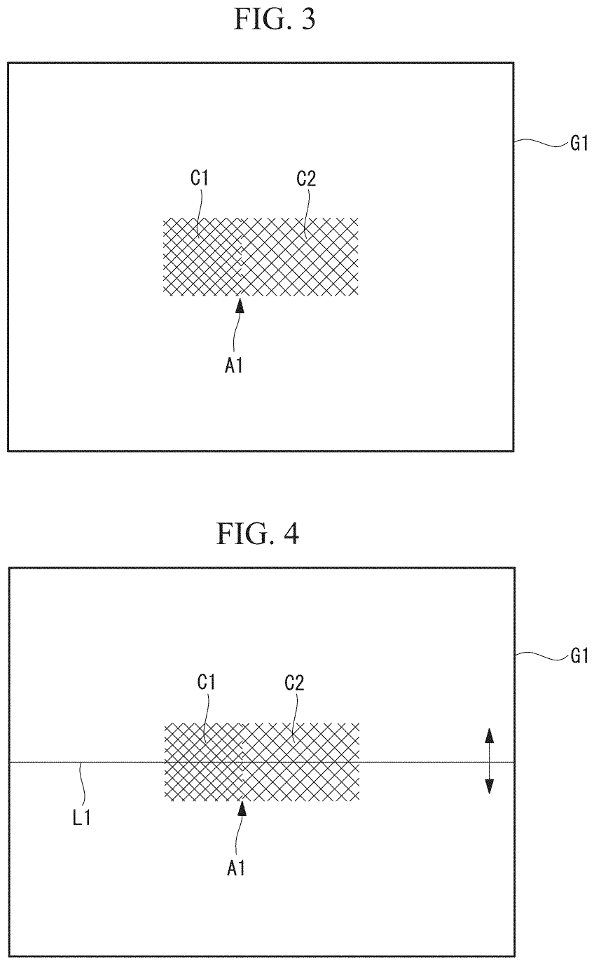

As shown in FIG. 3, the image processing apparatus 120 generates the first distance image G1 by assigning a color or density corresponding to the distance from the three-dimensional camera 110 of the object W positioned at each of the pixels C1 and C2 in the three-dimensional image to each of the pixels C1 and C2 in the state of being initialized to a relatively large distance range A1 in which the object W is expected to be present.

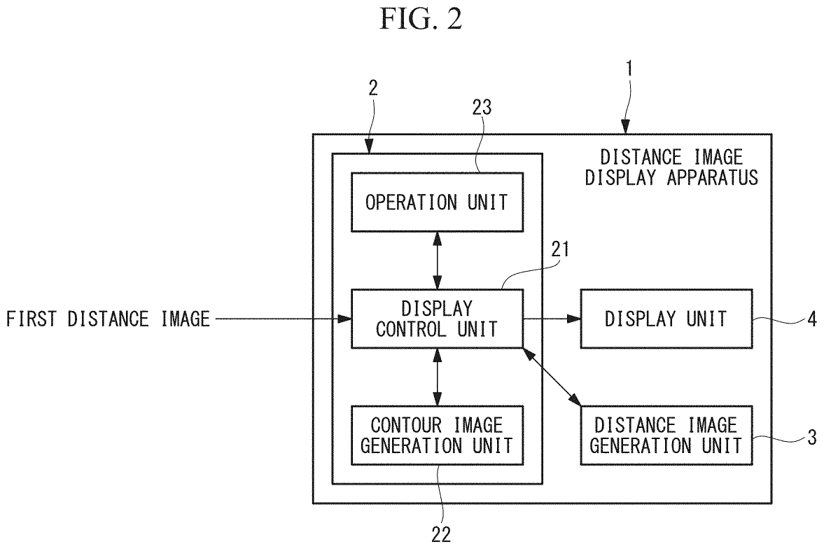

As shown in FIG. 2, the distance image display apparatus 1 according to this embodiment includes a distance range specifying unit 2 that allows an operator to specify a distance range A2 desired to be displayed, a distance image generation unit 3 that generates a second distance image G2 in which a color or density of each of the pixels C1 and C2 positioned within the specified distance range A2 is reassigned so as to correspond to the distance from the three-dimensional camera 110, and a display unit 4 that displays the generated second distance image G2.

The distance range specifying unit 2 includes a display control unit 21, a contour image generation unit 22, and an operation unit 23. The display control unit 21 displays the inputted first distance image G1 on the display unit 4 as shown in FIG. 3 and displays on the display unit 4 a line L1 that is movable on the first distance image G1 displayed on the display unit 4 as shown in FIG. 4. The line L1 is for allowing specification of a plane passing through the pixels C1 and C2 positioned within the distance range A1 and extending in the distance direction (the direction perpendicular to the paper surface in FIG. 4) and can be moved by the operator to any position on the first distance image G1 by using the operation unit 23.

The operation unit 23 is any operation input unit such as a mouse, a keyboard, or a touch display.

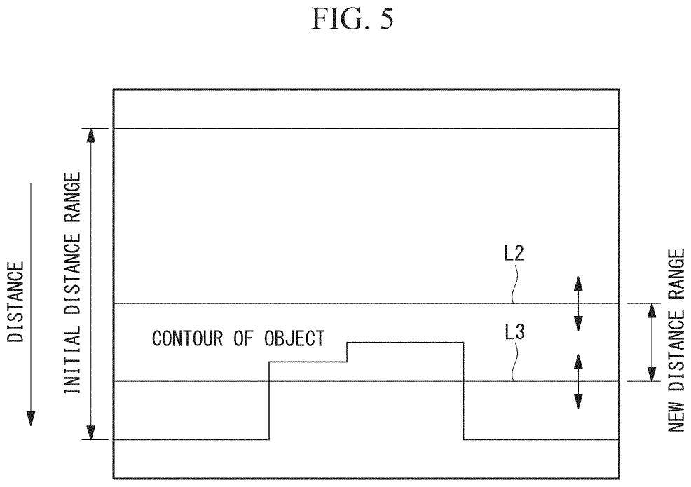

When the position of the line L1 displayed on the first distance image G1 by the display control unit 21 is set using the operation unit 23, the contour image generation unit 22 generates a contour shape of the object W along a plane including the specified line L1 and extending in the distance direction. When the contour shape of the object W along the specified plane is generated, the display control unit 21 displays the generated contour shape on the display unit 4 as shown in FIG. 5 and displays two parallel lines L2 and L3 on the display unit 4 that are movable in the distance direction (the direction of the arrow) for allowing specification of the distance range A2 in the displayed contour shape.

By the operator moving the two lines L2 and L3 using the operation unit 23, the display control unit 21 specifies a range sandwiched between the two lines L2 and L3 as the distance range A2 desired to be displayed as a distance image.

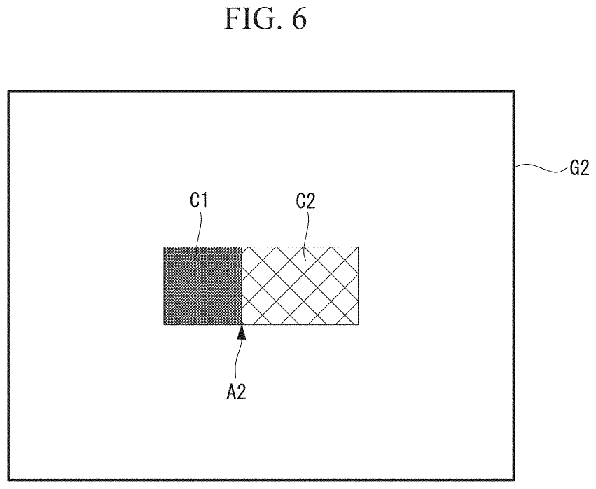

When the distance range A2 is specified, the display control unit 21 sends the specified distance range A2 to the distance image generation unit 3, and the second distance image G2 in which a color or density of each of the pixels C1 and C2 positioned within the specified distance range A2 is reassigned so as to correspond to the distance from the three-dimensional camera 110 is generated in the distance image generation unit 3 as shown in FIG. 6,

The display control unit 21 displays the second distance image G2 generated by the distance image generation unit 3 on the display unit 4.

The image processing apparatus 120, the display control unit 21, the contour image generation unit 22, and the distance image generation unit 3 are configured by a processor, and the display unit 4 is configured by a monitor.

The distance image display method using the distance image display apparatus 1 according to this embodiment configured in this way will be described below.

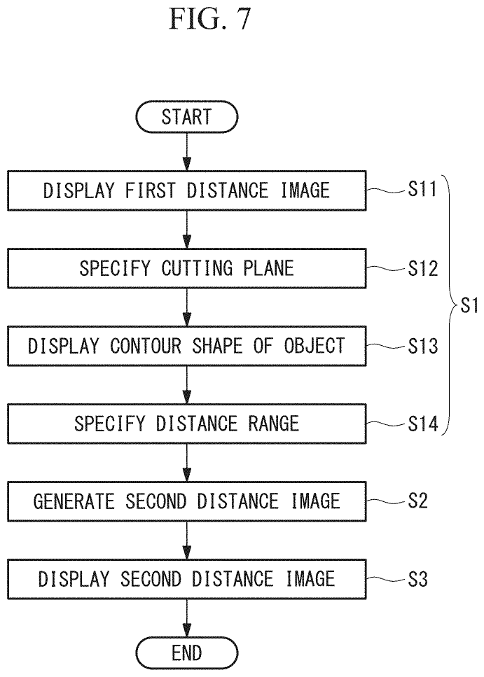

In the distance image display method according to this embodiment, as shown in FIG. 7, when the first distance image G1 is inputted in which, based on the three-dimensional image of the object W acquired by the three-dimensional camera 110, a color or density corresponding to the distance of the object W from the three-dimensional camera 110 at each of the pixels C1 and C2 is assigned to each of the pixels C1 and C2, the operator is allowed to specify the distance range A2 desired to be displayed within the first distance image G1 (step S1), the second distance image G2 is generated in which a color or density of each of the pixels C1 and C2 positioned within the specified distance range A2 is reassigned so as to correspond to the distance from the three-dimensional camera 110 (step S2), and the generated second distance image G2 is displayed (step S3).

In step S1 for allowing the operator to specify the distance range A2 desired to be displayed, as shown in FIG. 7, the first distance image G1 is displayed on the display unit 4 (step S11), and the line L1 passing through the pixels C1 and C2 positioned within the distance range A2 desired to be displayed in the displayed first distance image G1 is allowed to be moved using the operation unit 23, thereby allowing specification of a plane (cutting plane) including the line L1 and extending in the distance direction (step S12). Then, a contour shape of the object W along the specified plane is displayed on the display unit 4 (step S13), and the distance range A2 is allowed to be specified by moving the two lines L2 and L3 in the displayed contour shape (step S14).

In the distance image display apparatus 1 and the distance image display method according to this embodiment, the second distance image G2 is displayed in which colors or densities are reassigned to the distance range A2 that is sufficiently narrower than the initial distance range A1 that is set over a wide range in which the object W is expected to be positioned, thus providing an advantage that a difference in distance within the desired distance range A2 in the three-dimensional image acquired by the three-dimensional camera 110 can be displayed in a finely distinguishable manner.

That is, since a color or density is assigned in the distance image in a smooth or gradually changing manner with a change in distance, the colors or densities of two surfaces that are close in the distance direction are similar to each other to be difficult to distinguish in the first distance image G1 shown in FIG. 3 in which colors or densities are assigned to the relatively wide initial distance range A1. In contrast, in the second distance image G2 shown in FIG. 6 in which colors or densities are reassigned to the distance range A2 that is sufficiently narrower than the initial distance range A1, the colors or densities of two surfaces that are close in the distance direction can be differentiated largely, thus making it possible to display a difference in distance in a finely distinguishable manner.

In this embodiment, the first distance image G1 can be displayed on the display unit 4 to easily specify a cutting plane in the displayed first distance image G1 by using the line L1. In specification, since the operator has only to move the line L1 on the first distance image G1 to a position passing through the pixels C1 and C2 desired to be displayed as the second distance image G2 in which distances can be distinguished finely, this is simple and intuitive. Furthermore, also in specifying the distance range A2, it is possible to specify the distance range A2 simply and intuitively by displaying a contour shape of the object W along the cutting plane on the display unit 4 and sandwiching the contour shape between two parallel lines L2 and L3.

Note that although the distance range A2 is specified while displaying the contour shape of the object W along the cutting plane extending in the distance direction in this embodiment, this is not limitative, and it may be possible to allow the operator to specify, on the first distance image G1, pixels C1 and C2 or an area desired to be displayed as the second distance image G2 in which distances can be distinguished finely. It may also be possible to allow the operator to numerically input the distance range A2.

From the above-described embodiment, the following invention is derived.

An aspect of the present invention is a distance image display apparatus including: a distance range specifying unit that allows an operator to specify a distance range desired to be displayed within a first distance image in which, based on three-dimensional information of an object acquired by a three-dimensional camera, a color or density corresponding to a distance of the object from the three-dimensional camera at each pixel is assigned to each of the pixels; a distance image generation unit that generates a second distance image in which a color or density of each of the pixels positioned within the specified distance range is reassigned so as to correspond to a distance from the three-dimensional camera; and a display unit that displays the generated second distance image.

According to this aspect, when the first distance image is inputted that is generated based on the three-dimensional information of the object acquired by the three-dimensional camera, the distance range specifying unit allows the operator to specify the distance range desired to be displayed. When the distance range is specified, the second distance image in which a color or density of each pixel positioned within the specified distance range is reassigned so as to correspond to the distance from the three-dimensional camera is generated by the distance image generation unit. Then, the generated second distance image is displayed on the display unit.

Since the second distance image has a shorter distance range to which colors or densities are assigned than the first distance image, it is possible to finely assign colors or densities only to a distance range that the operator wants to display. This makes it possible to display a distance image in such a manner that a difference in depth within the specified distance range can be distinguished finely.

In the above aspect, the distance range specifying unit may allow specification of the distance range desired to be displayed by displaying the first distance image and allowing specification of the pixel positioned within the distance range desired to be displayed in the displayed first distance image.

This configuration enables the operator to indirectly and intuitively specify a distance range desired to be displayed by specifying a pixel desired to be displayed in such a manner that a difference in depth may be distinguished finely in the displayed first distance image.

In the above aspect, the distance range specifying unit may display the first distance image, allow use of a line passing through the pixel positioned within the distance range desired to be displayed in the displayed first distance image to specify a plane including the line and extending in a direction of the distance, display a contour shape of the object along the specified plane, and allow specification of the distance range in the displayed contour shape.

With this configuration, when the operator specifies a line passing through a pixel desired to be displayed in the displayed first distance image to specify a plane including the line and extending in the direction of the distance, the contour shape of the object along the specified plane is displayed.

The operator can directly and intuitively specify a distance range desired to be displayed in such a manner that a difference in depth may be distinguished finely in the contour shape of the object in a cross section that is cut by the plane extending in the direction of the distance from the three-dimensional camera.

In the above aspect, specification of the distance range in the contour shape may be performed by specifying positions and an interval of two lines that are apart in the direction of the distance and are parallel to each other.

This configuration makes it possible to easily specify a distance range desired to be displayed in such a manner that a difference in depth may be distinguished finely by adjusting the positions of the two lines.

Another aspect of the present invention is a distance image display method including: allowing an operator to specify a distance range desired to be displayed within a first distance image in which, based on three-dimensional information of an object acquired by a three-dimensional camera, a color or density corresponding to a distance of the object from the three-dimensional camera at each pixel is assigned to each of the pixels; generating a second distance image in which a color or density of each of the pixels positioned within the specified distance range is reassigned so as to correspond to a distance from the three-dimensional camera; and displaying the generated second distance image.

In the above aspect, specification of the distance range may be performed by displaying the first distance image and allowing specification of the pixel positioned within the distance range desired to be displayed in the displayed first distance image.

In the above aspect, specification of the distance range may be performed by displaying the first distance image, allowing use of a line passing through the pixel positioned within the distance range desired to be displayed in the displayed first distance image to specify a plane including the line and extending in a direction of the distance, displaying a contour shape of the object along the specified plane, and allowing specification of the distance range in the displayed contour shape.

In the above aspect, specification of the distance range in the contour shape may be performed by specifying positions and an interval of two lines that are apart in the direction of the distance and are parallel to each other.

### REFERENCE SIGNS LIST

1 Distance image display apparatus
2 Distance range specifying unit
3 Distance image generation unit
4 Display unit
110 Three-dimensional camera
A1, A2 Distance range
C1, C2 Pixel
G1 First distance image
G2 Second distance image
L1, L2, L3 Line
W Object

1. A distance image display apparatus comprising:
a distance range specifying unit that allows an operator to specify a distance range desired to be displayed within a first distance image in which, based on three-dimensional information of an object acquired by a three-dimensional camera, a color or density corresponding to a distance of the object from the three-dimensional camera at each pixel is assigned to each of the pixels;
a distance image generation unit that generates a second distance image in which a color or density of each of the pixels positioned within the specified distance range is reassigned so as to correspond to a distance from the three-dimensional camera; and
a display unit that displays the generated second distance image.

2. The distance image display apparatus according to claim 1, wherein the distance range specifying unit allows specification of the distance range desired to be displayed by displaying the first distance image and allowing specification of the pixel positioned within the distance range desired to be displayed in the displayed first distance image.

3. The distance image display apparatus according to claim 1, wherein the distance range specifying unit displays the first distance image, allows use of a line passing through the pixel positioned within the distance range desired to be displayed in the displayed first distance image to specify a plane including the line and extending in a direction of the distance, displays a contour shape of the object along the specified plane, and allows specification of the distance range in the displayed contour shape.

4. The distance image display apparatus according to claim 3, wherein specification of the distance range in the contour shape is performed by specifying positions and an interval of two lines that are apart in the direction of the distance and are parallel to each other.

5. A distance image display method comprising:
allowing an operator to specify a distance range desired to be displayed within a first distance image in which, based on three-dimensional information of an object acquired by a three-dimensional camera, a color or density corresponding to a distance of the object from the three-dimensional camera at each pixel is assigned to each of the pixels;
generating a second distance image in which a color or density of each of the pixels positioned within the specified distance range is reassigned so as to correspond to a distance from the three-dimensional camera; and
displaying the generated second distance image.

6. The distance image display method according to claim 5, wherein specification of the distance range is performed by displaying the first distance image and allowing specification of the pixel positioned within the distance range desired to be displayed in the displayed first distance image.

7. The distance image display method according to claim 5, wherein specification of the distance range is performed by displaying the first distance image, allowing use of a line passing through the pixel positioned within the distance range desired to be displayed in the displayed first distance image to specify a plane including the line and extending in a direction of the distance, displaying a contour shape of the object along the specified plane, and allowing specification of the distance range in the displayed contour shape.

8. The distance image display method according to claim 7, wherein specification of the distance range in the contour shape is performed by specifying positions and an interval of two lines that are apart in the direction of the distance and are parallel to each other.
